(19) United States
(12) Patent Application Publication
(10) Pub. No.: US 2025/0035911 A1
(43) Pub. Date: Jan. 30, 2025

(54) Microscopy system and method for processing a microscope image

(71) Applicant: Carl Zeiss Microscopy GmbH, Jena (DE)

(72) Inventors: Manuel Amthor, Jena (DE); Daniel Haase, Zoellnitz (DE)

(21) Appl. No.: 18/782,171

(22) Filed: Jul. 24, 2024

(30) Foreign Application Priority Data
Jul. 26, 2023 (DE) 10 2023 119 850.5

(51) Int. Cl. G02B 21/36; G06T 3/4084; G06T 5/50

(52) U.S. Cl. CPC G02B 21/367; G06T 3/4084; G06T 5/50; G06T 2207/10056; G06T 2207/20221

(57) ABSTRACT

In a computer-implemented method for processing a microscope image, the microscope image is converted into a downscaled microscope image and then input into a first image-to-image model. The first image-to-image model calculates a result image which differs in an image property from the downscaled microscope image. The microscope image is input together with the result image into a second image-to-image model, which calculates an output image that has a higher image resolution than the result image and resembles the result image in the image property.

### REFERENCE TO RELATED APPLICATIONS

The current application claims the benefit of German Patent Application No. 10 2023 119 850.5, filed on Jul. 26, 2023, which is hereby incorporated by reference.

### FIELD OF THE DISCLOSURE

The present disclosure relates to a microscopy system and a computer-implemented method for image processing a microscope image. In particular, the disclosure relates to image-to-image mappings of high-resolution microscope images.

### BACKGROUND OF THE DISCLOSURE

Image processing with machine-learned models is playing an increasingly important role in modern microscopes. Typically, deep learning methods, in particular deep neural networks, are used for image processing.

For example, cGANs (conditional generative adversarial networks) are used for image-to-image mappings, as described in:
Isola, Phillip, et al., “Image-to-Image Translation with Conditional Adversarial Networks”, arXiv:1611.07004v3 [cs.CV] 26 Nov. 2018

Image-to-image models take an input microscope image and calculate an output image therefrom that differs from the input microscope image in a targeted manner. Examples of image-to-image mappings include:
Virtual staining of a sample, wherein an input microscope image is processed so as to calculate an image therefrom which corresponds to an image that could be captured with a chemical staining or a fluorescence measurement of the sample. Such methods are described e.g. in: DE 10 2021/114 290 A1, DE 10 2021/114 291 A1, EP 3 553 165 A1, U.S. Pat. Nos. 9,786,050 B2, 10,013,760 B2 and in: Christiansen, Eric, et al., “In Silico Labeling: Predicting Fluorescent Labels in Unlabeled Images”, 2018, Cell 173, 792-803, 19 Apr. 2018, Elsevier, doi: https://doi.org/10.1016/j.cell.2018.03.040; and Ounkomol, Chawin, et al., “Label-free prediction of three-dimensional fluorescence images from transmitted light microscopy”, bioRxiv preprint, 23 May 2018, https://doi.org/10.1101/289504;
A contrast change or enhancement, e.g. a mapping from digital phase contrast to DIC contrast (DIC: differential interference contrast), as described by the Applicant in U.S. Pat. No. 11,579,429 B2;
Replication of a classic calculation method such as, e.g., a deconvolution in order to improve image quality;
A segmentation can also be regarded as a calculated image in this sense, for which a machine-learned model was described, inter alia, by the Applicant in DE 10 2021/105 020 A1.

The microscope images to be processed are often very large images, in particular due to a high camera resolution and/or in cases of a large field of view. Combining a plurality of raw images (image stitching) can result in a microscope image to be processed with a high image resolution of in principle any level. The application of image-to-image models to high-resolution input data is, however, computationally very intensive. Image-to-image models generally comprise more model parameters and, e.g., a larger number of processing layers in order to be able to process high-resolution input images in a desired quality. In addition to the actual processing of a microscope image, the training of an image-to-image model is also much more intensive computationally when the underlying training images have a high image resolution.

It has traditionally thus been necessary to accept either a high computational effort or a reduced image resolution.

Instead of a direct image-to-image mapping, it is in principle also possible for an image processing to be carried out in the feature space of a generative network. This was described, for example, by the Applicant in DE 10 2021/133 868 A1 for a GAN structure for improving an image quality of overview images. For a diffusion model as generative model, it is possible for a manipulation to be carried out in a feature space in a similar manner, as described, for example, in Preechakul, K., et al., “Diffusion Autoencoders: Toward a Meaningful and Decodable Representation”, arXiv:2111.15640v3 [cs.CV] 10 Mar. 2022. A projection of the image into the feature space of the generative network is necessary in this case, so that overall the computational effort required for an image manipulation is also very high.

### SUMMARY OF THE DISCLOSURE

It can be considered an object of the invention to indicate a microscopy system and a method which also efficiently enable an image processing of microscope images for high image resolutions.

This object is achieved by the microscopy system and the method with the features of the independent claims.

In a computer-implemented method of an embodiment according to the invention for image processing a microscope image, the microscope image is downscaled, whereby a downscaled microscope image is created. The downscaled microscope image is input into a first image-to-image model, which calculates a result image from at least the downscaled microscope image. The result image differs from the downscaled microscope image in at least one image property. The microscope image is then input together with the result image into a second image-to-image model, which calculates an output image that has a higher image resolution than the result image calculated by the first image-to-image model. The output image resembles (/corresponds to) the result image in at least one image property.

By means of the invention, an image is calculated that differs from the original microscope image and the downscaled microscope image in at least one image property, e.g. in a contrast type or staining method (phase contrast, bright field, fluorescence imaging, chemical staining) or a presence of artefacts (e.g. in the case of a removal of light reflections or contaminants from the microscope image). As the first image-to-image model processes a downscaled version of the microscope image with a reduced image resolution, the computational effort of the first image-to-image model is relatively low. The first image-to-image model generates a low-resolution result image with the desired image property, e.g., a virtually stained image from a microscope image that is a phase contrast image. This low-resolution result image can be used by the second image-to-image model as a “rough framework”, while the higher-resolution original microscope image provides fine details for the second part of the image-to-image mapping. The second image-to-image model may thus use two different input images together (the microscope image and the result image of the first image-to-image model) to calculate an output image. This allows the second image-to-image model to be relatively compact, e.g. it has relatively few model parameters or processing blocks. In contrast, a considerably more complex image-to-image model would be necessary if the model was intended to calculate the high-resolution output image directly from the original (high-resolution) microscope image. The procedure according to the invention, on the other hand, allows a high-quality output image to be generated with reduced computational effort.

A microscopy system of the invention comprises a microscope for imaging and a computing device configured to carry out the computer-implemented method of the invention.

A computer program of the invention comprises instructions which are stored on a non-volatile data storage medium and which, when the program is executed by a computer, cause the computer to execute the computer-implemented method of the invention.

### Optional Embodiments

Variants of the microscopy system according to the invention and of the method according to the invention are the object of the dependent claims and are explained in the following description.

The different variant embodiments enable an image-to-image mapping of a microscope image from a source domain into a target domain, i.e., with a change in at least one image property on a downscaled image, which efficiently enables a calculation. The upscaling of the result image uses the original microscope image as additional contextual information, whereby it is also possible for fine details to be reconstructed very well. As the second image-to-image model utilizes the result image of the first image-to-image model, it is no longer necessary to calculate the more complex transition into the target domain, so that the computational effort for the second image-to-image model is moderate.

For full-resolution images, on the other hand, a domain transformation would require a high model complexity and therefore a long runtime. The calculation of the transformation requires a lot of context, which results in a large receptive field and thus a long computation time. By comparison, the domain transformation by the first image-to-image model in the low-resolution space is economical. The upscaling using the result and the original microscope image operates more patchwise. There merely occurs a fine sharpening of structures, which requires significantly less computational power and model complexity.

A further relevant advantage of the two models working in series is that structures that are often distorted or poorly reconstructed by a domain transformation (of the first image-to-image model) can be rectified by the upscaling step of the second image-to-image model. For example, cover slip edges that are straight edges in the microscope image often become wavy lines in the result image due to the domain transformation. During the upscaling, the cover slip edges become straight lines again in the final output image through the second image-to-image model.

### Training Data; First Image-to-Image Model

Microscope images provided for the training of the first or second image-to-image model are also referred to as training microscope images in order to distinguish these images terminologically from microscope images that are processed in the inference phase after the model training.

For the training of the first and second image-to-image models, training data is provided which comprises a plurality of training microscope images and associated target images. The training microscope images and the target images differ in at least one image property. Moreover, a training microscope image and the associated target image can form a registered image pair, i.e., they show the same objects/structures at corresponding image coordinates.

For the training of the first image-to-image model, downscaled training microscope images are calculated from a plurality of the training microscope images. Downscaled target images are also calculated from the associated target images (i.e., from the target images associated with the aforementioned training microscope images). In the training of the first image-to-image model, the downscaled training microscope images are used as inputs and the downscaled target images are used as targets. One of the downscaled microscope images and the associated downscaled target image respectively constitute an image pair.

The result image that the first image-to-image model calculates from an input downscaled microscope image should ideally match the associated downscaled target image.

An image resolution of the downscaled target images used in the training of the first image-to-image model can be lower than an image resolution of the microscope image (which is processed after the training).

The calculation of a downscaled target image from a target image can occur before the training, wherein the downscaled target image is saved as an image file. Alternatively, the calculation of a downscaled target image from a target image can also occur within a calculation step of the training of the first image-to-image model. For example, the loss function can encompass an image downsizing of a target image. A (high-resolution) target image can thereby have a higher resolution than an associated, downscaled microscope image, wherein the loss function predetermines how a difference is formed between pixels of the result image and the (high-resolution) target image. By way of example, in a simplified case the target image can comprise twice as many rows and columns i, j as the downscaled microscope image, wherein a pixel i, j of the result image is compared with a pixel 2i, 2j of the target image in the loss function. The loss function can involve more complex calculation methods: for example, a calculation that uses the target image and a low-pass filter and subsampling can be performed.

Once it has been trained, the first image-to-image model can calculate result images that correspond in their image property to the image property of the target images and accordingly differ in the image property from the input downscaled microscope images. The first image-to-image model thus calculates a mapping from a source domain to a target domain, wherein the source and target domains differ in the value of the image property.

In principle, the first image-to-image model can also be replaced or designed by a generative network, wherein the mapping into the target domain is implemented by manipulating a latent space representation of the downscaled microscope image in the feature space of the generative network. The generative network is trained using downscaled training microscope images and downscaled target images, which do not necessarily have to be co-registered image pairs. In particular, the generative network can be designed in a GAN structure or as a diffusion model, as explained in the introduction with reference to the prior art.

The first image-to-image model is configured to calculate the result image with an image resolution that is lower than an image resolution of the microscope image (and/or of the output image from the second image-to-image model). The image resolution of the result image can be equal to or greater than the image resolution of the downscaled microscope image.

### Downscaling Microscope Images

By downscaling a microscope image, the number of pixels in the image is reduced. This can occur for columns and/or rows of the microscope image. Downscaling is not intended to be understood as a cropping of a microscope image, whereby a visible area of the downscaled microscope image would be smaller than a visible area of the microscope image. The calculation method used for downscaling can in principle be any appropriate calculation method. In particular, the downscaling can occur classically, for example by means of a low-pass filter followed by a subsampling, or by means of a bilinear/bicubic interpolation or a Fourier transform-based method. The scaling can also be data-based.

A scaling factor can be manually selectable, fixed (e.g., as part of a workflow), or can be defined so as to be automatically variable, e.g., via an analysis of the image content and/or as a function of contextual information. In particular, the microscope image can be analyzed in order to determine a structure size of depicted structures. The structures can be, e.g., biological cells, cell organelles, electronic components to be analyzed, sample carriers or sample carrier parts. The structure size is intended to be understood as the size in image pixels. A scaling factor for downscaling the microscope image is defined as a function of the determined structure size, in particular so that the structure size lies within a predetermined range after the downscaling. Depending on the scaling factor, the downscaling thus results in a different number of pixels in the downscaled microscope image, although a pixel size of depicted structures is standardized to a standard object size.

The downscaled training microscope images can be formed analogously. In particular, the downscaled training microscope images for the first image-to-image model can be formed by downscaling training microscope images so that depicted structures have a common/corresponding structure size. “Corresponding” can be understood here as equal within a predetermined pixel range. As occurring structure sizes are limited to a predetermined pixel range, the data variance is reduced and less training data will suffice. This eliminates a large part of the required complexity for the first model, which simultaneously generalizes much better. It is also ensured that the first image-to-image model is suitable for newly captured microscope images to be processed largely regardless of an image resolution or image size.

The resolution can be reduced to different degrees for the two image axes, or only along one image axis. The downscaled microscope image is thereby compressed, e.g. a non-square microscope image can be transformed into a square, downscaled microscope image. This can be advantageous in particular when a special network architecture which favors square input images (or input images with a given aspect ratio) is used for the first image-to-image model. The compression can subsequently be reversed by the second image-to-image model.

### Processing/Upscaling the Result Image of the First Image-to-Image Model

The result image calculated by the first image-to-image model can be input into the second image-to-image model in unaltered form or in processed form. In particular, the result image calculated by the first image-to-image model can be upscaled before it is input into the second image-to-image model. The upscaling can occur so that an image size in pixels corresponds to an image size of the microscope image. The calculation method for the upscaling can be any appropriate calculation method, wherein in particular classical methods such as bilinear or bicubic algorithms can be employed.

In addition or alternatively to an upscaling, a processed form of the result image can also be calculated by a further machine-learned model. The further machine-learned model may be, for example, a virtual staining model in case the first image-to-image model is an artefact removal model, as described later on in greater detail.

### Training of the Second Image-to-Image Model

A training of the second image-to-image model utilizes the training data from which the images for the training of the first image-to-image model were also drawn. This means that either (at least partially) the same images are used for the training of the first and second image-to-image models, or the images are at least drawn from the same data set/the same distribution. Optionally, result images calculated by the first image-to-image model can also be used for the training of the second image-to-image model, as described in more detail in the following.

In a training of the second image-to-image model, an input into the second image-to-image model comprises at least two input images that are processed simultaneously/together by the model. One of these input images is one of the training microscope images of the training data. The other of the two input images is one of the following: a downscaled target image associated with the aforementioned training microscope image, or a result image calculated by the (ready-trained) first image-to-image model from the aforementioned training microscope image, or a processed image based on the downscaled target image and/or on the result image calculated from the training microscope image. The target image associated with the aforementioned training microscope image is used as the target in the training.

Thus, while an input into the second image-to-image model comprises one of the training microscope images, the downscaled version of (the same or a different) training microscope image is input into the first image-to-image model. The target for the training of the second image-to-image model is precisely a target image from which the downscaled target image for the training of the first image-to-image model was calculated, or at least the target image and the downscaled target image come from the same training data. The target images for the training of the second image-to-image model thus correspond to the downscaled target images in the image property and differ from the downscaled target images in that they have a higher image resolution. The output images calculated by the second image-to-image model are intended to correspond to the target images in the image property.

If a downscaled target image is used as the second input image, it is calculated precisely from the target image that is simultaneously used as the target. In the case of a processed image as the second input image, this can be, e.g., an upscaled version of the result image (of the first image-to-image model) or an upscaled version of the downscaled target image or a combination of the result image and the downscaled target image. The combination can consist in, e.g., an averaging of said images. An upscaled version of the downscaled target image differs from the original target image because information is lost through the downscaling; the image resolution of the upscaled version can be the same or generally also different from the image resolution of the original target image.

In principle, a (training) microscope image can be processed before it is input into the second image-to-image model, while the downscaled microscope image for the first image-to-image model is not processed in this manner. Conversely, an additional processing of the (in particular downscaled) (training) microscope image can also only take place for the first image-to-image model, but not for the second image-to-image model. The processing can comprise, for example, a noise suppression, a contrast enhancement or a change in image brightness.

The training of the second image-to-image model can occur independently of the training of the first image-to-image model. Alternatively, it is also possible for both image-to-image models to be trained together, in particular using a common loss function. A common loss function comprises a part into which the result image of the first image-to-image model is input and a part in which the output image of the second image-to-image model is taken into account. By means of these two parts, a backpropagated loss can be apportioned between the two image-to-image models in order to adjust model parameter values.

### Upsampling by the Second Image-to-Image Model

If the two images to be input into the second image-to-image model have different image resolutions, the second image-to-image model first performs an upscaling (upsampling) of the smaller image until its image resolution matches the image resolution of the (training) microscope image. When the image resolutions correspond, the image data is combined (concatenated). Subsequent processing layers of the second image-to-image model collectively work on the concatenated image data. If the input result image has the same image resolution as the simultaneously input microscope image (or if an upscaled version of the result image or of the downscaled target image which has the same image resolution as the training microscope image is used as input in the training), the second image-to-image model can process both images directly together without the need for an upsampling.

The second image-to-image model can comprise two separate input paths (input branches) for the two images to be input, wherein the two input paths run into a common model section (referred to as model trunk). Optionally, only the input image which has a lower resolution runs through a section consisting of a plurality of upsampling layers and, upon reaching a target image size, is merged with the input layer of the original (training) microscope image in an intermediate layer. The (training) microscope image does not have to run through separate processing layers before the merger; this is, however, optionally possible.

In other words, the second image-to-image model can comprise a first input section with processing layers in which an input result image is upscaled. The input microscope image, on the other hand, does not run through the first input section. An output of the first input section is processed together with the microscope image (or a tensor calculated from the microscope image) by subsequent processing layers in order to calculate the output image.

The internal resolution can increase continuously in the plurality of processing layers of the first input section, which only the result image runs through. Cascaded upsampling blocks can be used to this end; in particular, a bilinear upsampling, a deconvolution or a transposed convolution can be employed. In a transposed convolution, zeros (or constants in general) are added to the input tensor (input feature map), for example a zero can be inserted between two neighboring elements in each column and each row (stride) and/or a frame of zeros can be added around the outside of the input tensor (padding), and only then is the convolution calculation performed. Optionally, the input result image can pass through a bottleneck (a bottleneck layer), i.e., the internal resolution first falls before it rises to the target value.

It can also be provided that an internal resolution remains constant. That is to say that the model is isotropic and essentially consists of a cascade of processing blocks, which respectively contain operations for convolution, activation and normalization. A constant internal resolution can apply to the first image-to-image model and/or to the second image-to-image model, i.e., to a model trunk of the second image-to-image model which both input images pass through.

In a variant of the described embodiments, the upsampling blocks can also form an end of the first image-to-image model instead of an input section of the second image-to-image model. In this case, the inputs of the first image-to-image model are still downscaled microscope images, so that the computational effort is reduced compared to conventional methods. The target images can be used as the target in the training of the first image-to-image model, so that downscaled target images are not absolutely necessary in this embodiment. It is also possible, however, for a loss function with two components to be used, wherein one component captures a comparison between an intermediate layer output and downscaled target images and one component of the loss function compares the final result image with (non-downscaled) target images. The benefit of the second image-to-image model in this embodiment likewise lies in the fact that it is possible to take into account detail structures missing in the downscaled microscope images using the high-resolution microscope images, so that the output image of the second image-to-image model is refined compared to the result image of the first image-to-image model. However, the advantage in terms of a reduction of computation time can be less pronounced with this approach than with the embodiments described in the foregoing.

### Microscope Images and Target Images

A microscope image is understood in the present disclosure as image data processed by the image-to-image models of the invention and captured by a microscope or obtained by processing raw data captured by a microscope.

The target image can likewise be image data captured by a microscope or obtained by processing raw data captured by a microscope.

A microscope image and a target image can be 2D image data, 3D or multidimensional image stacks or volumetric data, or alternatively also time series data in which 2D or 3D image data of the same sample were captured at different times. The microscope image and the associated target image do not have to be of the same type. For example, the microscope image can be a 2D image while the target image (and the downscaled target image) is a 3D image stack, so that it is learned to calculate a 3D image stack based on an input 2D image.

A microscope image and an associated target image can in particular be obtained by different microscopes, different microscopy techniques or contrast methods, different microscope settings or different sample preparations. It is also possible for a target image to be generated by image processing a microscope image.

The microscope image can also be a (macroscopic) overview image from an overview camera on the microscope or calculated from measurement data from at least one overview camera. Structures or objects depicted in microscope images can in principle be any structures or objects, e.g., a sample vessel, a sample carrier, a microscope component such as a sample stage or areas of the same. Biological structures, electronic elements or rock parts can also be depicted.

A microscope image can be provided by means of a manual imaging with a microscope or by an automated imaging, e.g. as part of a workflow. The microscope image can also be an existing image that is loaded from a memory or network.

### Areas of Application of the Image-to-Image Models

The first and second image-to-image models receive at least one (downscaled) microscope image as input, which they use to calculate an image (referred to in the present disclosure as the output image or result image) that differs from the microscope image in at least one image property. The image-to-image models thus calculate an image-to-image mapping between two domains that differ in the image property.

The calculations of the second image-to-image model can be interpreted in the sense of the use of a miniature version of the desired result image as contextual information for the transformation (of the high-resolution microscope image) into the target domain. In the inference phase, the miniature version is provided by the first image-to-image model. The calculation performed by the second image-to-image model can alternatively be interpreted as a calculation of a high-resolution version of the miniature image (i.e., of the output image calculated by the first image-to-image model) using the high-resolution microscope image as contextual information, i.e., detailed information for the generation of the high-resolution output image is obtained from the input (high-resolution) microscope image.

The target domain or image property in which the input and target images differ can in principle be any domain or image property. The image property can also be called the image type and relate in particular to one or more of the following:
Visibility of artefacts or interfering structures: In cases where artefact-free images are used as target images, an artefact removal can be learned. The artefacts can be, e.g., light reflections, a shading, color errors or optical imaging errors. Artefacts do not necessarily have to be present in captured raw data, but can also be the result of an image processing, in particular in cases of a model compression. A model compression simplifies a machine-learned model in order to reduce the memory or computational requirements of the model, wherein the model accuracy can be slightly reduced and artefacts can appear in the output microscope images as a result of the model compression. Images which do not contain any interfering structures or in which interfering structures have been suppressed can be used as target images. Interfering structures can take the form of, for example, contaminants (e.g., lint, dust, hair or fingerprints), a background that is visible through a transparent sample carrier, retaining clips for a sample carrier or scratches on a sample carrier.
A virtual staining: The (training) microscope images and target images are captured with different contrast types, e.g. bright field, DIC (differential interference contrast), fluorescence images. These can be used to learn, e.g., an image-to-image mapping from a DIC image to a fluorescence image. Alternatively or in addition to the employed contrast type, a microscope image and a target image can also differ in a sample preparation, for example in a chemical staining.
A size of a depicted region of analysis: Object regions that are missing in the input microscope image are intended to be filled in based on adjacent captured object regions (inpainting). The microscope images differ from the target images at least in that given image regions are missing. In the training, e.g., images captured by the microscope can be used as target images while the training microscope images are formed by removing image regions from target images.
Segmentation: The image property can indicate whether a (semantic) segmentation mask exists. The target images used for the training are (semantic) segmentations of the microscope images or co-registered images, wherein a membership in one of a plurality of classes is indicated for each pixel by the corresponding pixel value. The classes can designate, for example, sample carrier types, sample types, sample states, a local defocusing, an image quality, a level of contamination, a sample-vessel fill level, object sizes or heights of depicted objects. A pixelwise or regionwise classification is carried out, whereby the associated class is predicted for each pixel or image region of an input microscope image. An instance segmentation is also possible.
Information regarding a local defocusing or contamination. A defocusing or a contamination can vary across a microscope image, so that the estimation of a local level of the defocusing or contamination per pixel or image region of the microscope image can be useful. A map in which a pixel value indicates the level of the defocusing or contamination for a locally corresponding pixel of the microscope image can be used as the target image.
Object visibility: Depicted objects can be more clearly visible or displayed in a higher image quality in the target image than in the input microscope image. The improved visibility or higher image quality can relate to depicted objects in general, as, e.g., in the case of a noise reduction (denoising), contrast enhancement (e.g. an adjustment of the gamma value or a contrast spread) or deconvolution. It is also possible, however, for the improved visibility to relate solely to given objects, as in the case of a transformation between different contrast types, whereby a virtual staining of given structures is achieved.
Distortion/perspective representation: The microscope images and target images can differ in a viewing direction or perspective distortion. For example, the microscope images can be oblique views of a sample carrier or a macroscopic sample captured by an overview camera, while the target images are plan views (either captured separately or calculated from the oblique views).

Target images can also be density maps of depicted objects, e.g. by marking cell or object centers. A white balance, an HDR image or a de-vignetting can also be calculated. A white balance removes a distorting color tone from the input microscope image so that colorless objects are actually depicted as colorless in the result/output image. In an HDR image, a scale of possible brightness differences per color channel is increased compared to the input microscope image. De-vignetting removes an edge shading of the input microscope image or generally also other effects that increase towards the image edge, such as a change in color, imaging errors or a loss in image sharpness. A signal separation (“unmixing”) is also possible in which one or more signal components are extracted, e.g., in order to estimate an extraction of a spectral range from a captured image.

Microscope images and result images can also differ in a plurality of the aforementioned image properties, for example in an artefact removal and additionally in a viewing angle or in a virtual staining.

Result images can be analyzed automatically for further applications, for example for counting biological cells or other objects or for a confluence analysis, i.e., for estimating a surface area covered by cells.

### Cascaded Models; Model Alternatives

One or more further image-to-image models can also be interposed between the first and second image-to-image models. Such a further image-to-image model receives the result image of the first image-to-image model as input and calculates therefrom an image (also referred to in the present disclosure as a “processed form of the result image”). The at least one further image-to-image model can be any of the aforementioned examples mentioned with respect to areas of application. For example, the first image-to-image model can perform a background suppression or a virtual staining, while the further image-to-image model calculates a semantic instance segmentation. As a further example, the first image-to-image model and one or more subsequent image-to-image models can serve to remove artefacts of different artefact classes/different types of interfering objects (e.g., one model can remove light reflections, while another model removes contaminants on a sample carrier and another model brightens shaded areas). As a further example, a semantic segmentation (of, e.g., artefacts) can be followed by an inpainting to replace the segmented (artefact) regions based on a surrounding image content.

If one or more further image-to-image models are interposed between the first and second image-to-image models, the output image of the second image-to-image model differs from the original microscope image in a plurality of image properties, in particular in a plurality of the aforementioned image properties. The downscaled target images (for the training of the first image-to-image model) differ in this case from the target images (for the training of the second image-to-image model) not only in the scaling but also in the image property changed by the interposed image-to-image model.

It can also be provided for there to be a plurality of variants of the first image-to-image model and/or a plurality of variants of the second image-to-image model, wherein one of the variants is selected for processing the microscope image as a function of the image content of the microscope image and/or as a function of contextual information. For example, a plurality of variants of the second image-to-image model can be trained for different illuminations, i.e., the training images used for these variants differ in illumination. One of the model variants is selected as a function of the illumination at the capture of the microscope image. For example, the system configuration or a microscope setting with which a microscope image was captured, in particular a contrast type, illumination or detection settings or the selection of employed microscope components, can serve as contextual information. Information regarding the employed sample, the experiment or the user can also serve as contextual information. This information can be helpful for the upscaling by the second image-to-image model, in particular in cases of structures that are difficult to reconstruct. If the first image-to-image model is a virtual staining model, a model variant can be selected from different model variants as function of a type of employed sample and/or an employed dye.

### Model Architecture

An architecture of the image-to-image models can in principle be any appropriate architecture so long as at least one image (or at least two images) is captured as input and at least one image (output image/result image) is output. It is possible to employ a neural network, in particular a parameterized model or a deep neural network, which in particular contains processing blocks with convolutional layers. The model can comprise, e.g., one or more of the following: • encoder networks for a classification or regression, e.g. ResNet or DenseNet; • an autoencoder, which is trained to generate an output that is ideally identical to the input; • generative adversarial networks (GANs), in particular cGANs (conditional GANs), e.g. Pix2Pix, or CycleGANs; • encoder-decoder networks, e.g. U-Nets, in particular with (self-)attention layers; • diffusion models, in particular with U-Net architecture, which calculate an image synthesis via a denoising; • feature pyramid networks; • fully convolutional networks (FCNs), e.g. DeepLab; • sequential models, e.g. RNN (recurrent neural network, RNN), LSTM (long short-term memory) or transformers; • fully connected models, e.g. multi-layer perceptron networks (MLP). The network can also have skip and residual connections, as is usually the case with U-Nets.

An internal resolution of the first and/or second image-to-image model can initially fall and then rise again after a bottleneck up to the target size, as is common with many U-Nets.

The receptive field of the employed image-to-image models can be selected so as to be rather small, whereby the achieved advantage in terms of speed is particularly pronounced. This also prevents an inclusion of unnecessary spatial information in the calculation of a pixel of the output image, as often occurs in the event of an overfitting.

### General Features

The microscope can be a light microscope which comprises a system camera and optionally a separate overview camera. The overview camera does not utilize an objective with which the system camera captures sample images of a higher magnification, and the overview camera can in particular be arranged so that it generally does not receive light by way of microscope objectives. Other types of microscopes are also possible, for example electron microscopes, X-ray microscopes or atomic force microscopes. A microscopy system refers to an apparatus which comprises at least one computing device and a microscope.

The computing device can be designed in a decentralized manner, be physically part of the microscope or be arranged separately in the vicinity of the microscope or at a remote location at any distance from the microscope. It can generally be formed by any combination of electronics and software and can in particular comprise a computer, a server, a cloud-based computing system or one or more microprocessors or graphics processors. The computing device can also be configured to control microscope components. A decentralized design of the computing device can be utilized in particular when a model is learned by federated learning by means of a plurality of separate devices.

Method variants can optionally comprise the capture of microscope images and/or target images by the microscope, while in other method variants existing microscope images and/or target images are loaded from a memory.

Descriptions in the singular are intended to cover the variants “exactly 1” as well as “at least one”. For example, the inputting of the downscaled microscope image into the first image-to-image model can mean that exactly one downscaled microscope image is input and processed or that more than one downscaled microscope image is input and processed together. For example, a plurality of (downscaled) microscope images captured from different perspectives or with different exposure times can be processed simultaneously in order to calculate a result image.

An image resolution is intended to be understood as the number of pixels in an image. The image resolution thus differs from an optical resolution or measurement resolution, which can be defined, e.g., as the distance between distinguishable sample points.

“High-resolution” can be understood in the present disclosure in the sense of a distinction from downscaled images. A microscope image is also referred to as a high-resolution microscope image and has a higher number of pixels than the downscaled microscope image. This also applies to (high-resolution) target images.

Different invention variants are described in terms of how machine-learned models are trained or which training data is provided for a model training. Further invention variants result from the implementation of the corresponding training. Conversely, described training sequences also yield invention variants in which models are formed in accordance with these training sequences without the implementation of the training per se forming a part of the variant embodiment.

Described image-to-image models are learned models that are learned by a learning algorithm based on training data. The models can respectively comprise, for example, one or more convolutional neural networks (CNN), which receive a vector, at least one image or image data as input. Model parameters of the model are defined by means of a learning algorithm using the training data. To this end, a predetermined objective function is optimized, e.g. a loss function is minimized. To minimize the loss function, the model parameter values are modified, which can be calculated e.g. by gradient descent and backpropagation. In the case of a CNN, the model parameters can in particular comprise entries of convolution matrices of the different layers of the CNN. Other model architectures of a deep neural network are also possible.

The characteristics of the invention that have been described as additional apparatus features also yield, when implemented as intended, variants of the method according to the invention. Conversely, a microscopy system or in particular the computing device can be configured to carry out the described method variants.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 schematically illustrates an image-to-image mapping according to the prior art;

FIG. 2 schematically shows processes of an example embodiment of the method according to the invention;

FIG. 3 schematically shows processes of an example embodiment of the method according to the invention;

FIG. 4 schematically shows processes of a further example embodiment of the method according to the invention; and

FIG. 5 is a schematic illustration of an example embodiment of a microscopy system according to the invention.

### DETAILED DESCRIPTION OF EXAMPLE EMBODIMENTS

Different example embodiments are described in the following with reference to the figures.

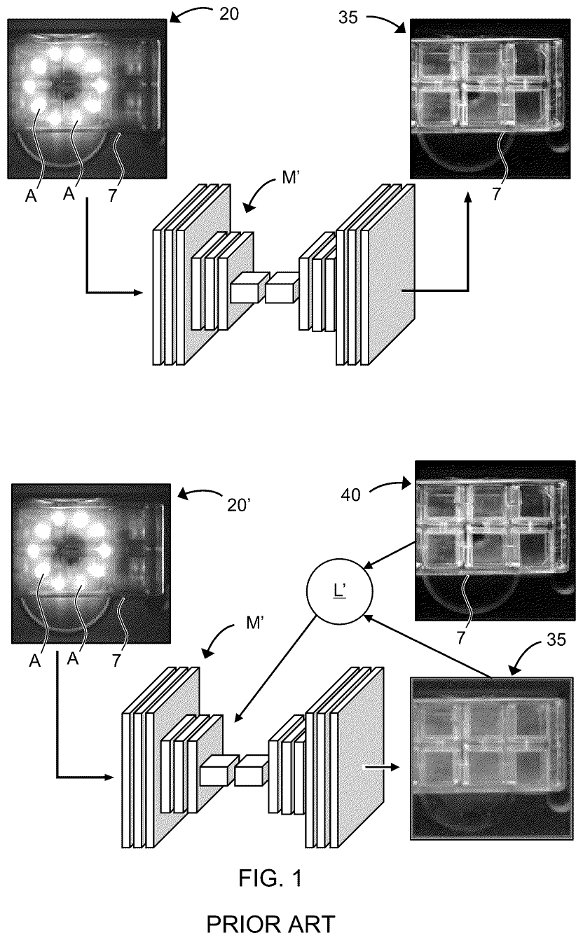

### FIG. 1: Image-to-Image Mapping According to the Prior Art

FIG. 1 schematically shows the use of an image-to-image model M′ of the prior art. The lower part of FIG. 1 illustrates a training of the image-to-image model M′, while the upper part of the figure shows the processing of a microscope image 20 by the image-to-image model M′ in the inference phase (after the training). The microscope image 20 is an overview image which shows a sample carrier 7 and contains a plurality of artefacts A, in this example light reflections from LEDs arranged in a circle, LEDs being typically employed in different microscopes.

In order to train the image-to-image model M′ for an artefact removal, training microscope images 20′ with artefacts A are used in the training as input in conjunction with associated target images 40 without artefacts. An output image 35 of the image-to-image model M′ is intended to resemble the artefact-free target image 40. In the training, a loss function L′ captures differences between the output image 35 and the target image 40, whereupon parameter values of the image-to-image model M′ are iteratively adjusted in a known manner. After the training, the image-to-image model M′ should be able to take an input microscope image 20 with artefacts and calculate therefrom an output image 35 which contains no artefacts but otherwise resembles the input microscope image 20.

Problems arise when high-resolution microscope images 20 are to be processed by the image-to-image model M′ of the prior art. The amount of computation time required in this case is disadvantageously large, which is also due to the considerable model size required to process high-resolution images in the desired manner with an adequate quality. However, in particular when the high-resolution microscope images are video images to be displayed in real time, a fast image processing is essential. Conventional methods can only provide this with exceptionally powerful hardware.

In contrast, the invention is able to achieve an artefact removal or other image-to-image mappings also for high-resolution images with less computational effort yet still a high quality. This is explained with reference to the following figures.

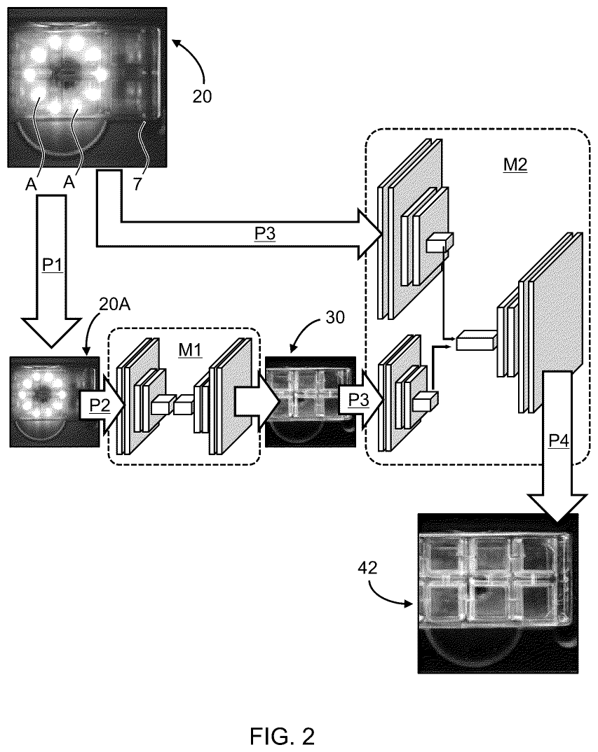

### FIG. 2: Image-to-Image Mapping with a Learned Model Pair of the Invention

An example embodiment of a computer-implemented method for image processing according to the invention is shown schematically in FIG. 2. A microscope image 20, which here shows a sample carrier 7 with overlapping artefacts A (reflections of an LED ring) by way of example, is to be processed with the method.

In process P1, a downscaled microscope image 20A is calculated by downscaling the microscope image 20. Downscaling reduces a number of pixels while the depicted image region (sample carrier 7 with surrounding area) remains the same.

The downscaled microscope image 20A, but not the (original) microscope image 20, is input into a first image-to-image model M1 in process P2, which calculates a result image 30 from the downscaled microscope image 20A. In this example, the image-to-image model M1 is trained for artefact removal, so that the result image 30 does not contain any artefacts A, but is otherwise identical to the input downscaled microscope image 20A. More generally, the result image 30 differs from the input downscaled microscope image 20A in an image property, which relates to, e.g., the visibility of artefacts, a contrast type (bright field, phase contrast, fluorescence, etc.) or a staining method (e.g. haemotoxylin-eosin or azan staining).

The result image 30 is input together with the microscope image 20 into a second image-to-image model M2 in process P3. The second image-to-image model M2 is trained to take such an image pair and to calculate therefrom an output image 42 (process P4) which has a higher image resolution than the downscaled microscope image 20A (and optionally also a higher image resolution than the result image 30) and resembles the result image 30 in the image property, i.e., in this example is free of artefacts. The image resolution can in particular be the same as the image resolution of the microscope image 20.

The second image-to-image model M2 essentially differs from typical super-resolution models in that it utilizes high-resolution structural details from the (high-resolution) microscope image 20.

The first image-to-image model M1 can be trained with relatively low computational effort and can perform the image-to-image mapping in the inference phase with relatively low computational effort because the input and output images have a relatively low resolution (lower than the microscope image and the final desired output images 42).

The second image-to-image model M2 can also be trained with relatively little computational effort and can generate the output image in the inference phase with relatively little computational effort. This is in part due to the fact that the use of the input image pair enables a more compact model structure. In contrast to the image-to-image model of the prior art of FIG. 1, the result image 30 can be utilized as contextual information or a miniature version of the desired result, so that the target domain has already been achieved, at least in a reduced image size. The remaining necessary processing steps are thereby less complex than in the image-to-image model of FIG. 1. According to an alternative interpretation, the second image-to-image model M2 performs an upscaling of the result image 30, wherein structural details are added by the microscope image 20—an upscaling and an addition of details are possible with significantly less computational effort or model complexity than the domain transition that must be implemented by the image-to-image model of FIG. 1.

A training of the first and second image-to-image models M1, M2 is described with reference to the next figure.

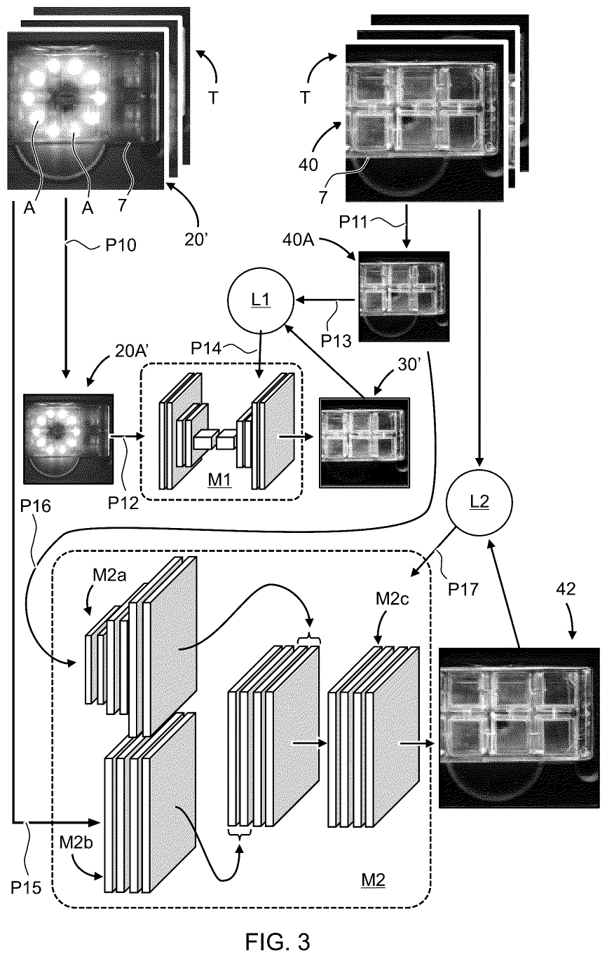

### FIG. 3: Training of the image-to-Image Models

FIG. 3 schematically shows a training of the first and second image-to-image models M1, M2 according to example embodiments according to the invention.

The training of the first image-to-image model M1 can be carried out separately or together with the training of the second image-to-image model M2.

Training data T is provided which comprises a plurality of training microscope images 20′ and associated target images 40. The target images 40 differ from the training microscope images 20′ in at least one desired image property, e.g. the presence of artefacts A.

A downscaled training microscope image 20A′ is calculated from a training microscope image 20′ in process P10. Analogously, a downscaled target image 40A is calculated from a target image 40 in process P11. The image resolution of the downscaled training microscope image 20A′ and the image resolution of the downscaled target image 40A can be the same. The downscaled training microscope image 20A′ is used as input for a training of the first image-to-image model M1 (process P12), while the downscaled target image 40A is used as ground truth/target (process P13). A result image 30′ calculated by the image-to-image model M1 from the input training microscope image 20A′ should ideally be identical to the downscaled target image 40A. To this end, a difference between the result image 30′ and the downscaled target image 40A can be captured, e.g., in a loss function L1, whereby model parameter values are iteratively adjusted, process P14. It is also possible to use another training design instead of the loss function L1. For example, a cGAN (conditional generative adversarial network) can be used. In a cGAN, a discriminator is used which receives as input a pair of images comprising either the downscaled training microscope image 20A′ and the result image 30′ or the downscaled training microscope image 20A′ and the downscaled target image 40A. The generator of the cGAN is constituted by the image-to-image model M1, which attempts to calculate result images 30′ that are classified as genuine (not generated) by the discriminator together with the associated downscaled training microscope image 20A′.

The training microscope images 20′ with the associated target images 40 are also used for the training of the second image-to-image model M2. These can be the same training microscope images 20′ and target images 40 that were used for the training of the first image-to-image model M1. Alternatively, pairs of training microscope images 20′ and associated target images 40 are randomly drawn from the training data T for the training of the first and second image-to-image models M1, M2.

In process P15, the second image-to-image model M2 receives as input one of the training microscope images 20′ which is not downscaled or in any case is generally downscaled to a lesser degree than the downscaled training microscope image 20A′. The second image-to-image model M2 also receives a further image as input (process P16), which differs in the image property (here: presence of artefacts) from the input training microscope image 20′ and instead resembles the target image 40 in the image property, but has a lower resolution than the target image 40. In the illustrated example, the additionally entered image is the downscaled target image 40A. Instead of a downscaled target image 40A, a result image could also be used, for example, which the ready-trained first image-to-image model M1 calculates from a downscaled version of the training microscope image 20′ that is input into the second image-to-image model M2.

The second image-to-image model M2 utilizes both input images to calculate an output image 42. The output image 42 has a higher image resolution than the downscaled target image 40A. In particular, the image resolution of the output image 42 can be the same as the image resolution of the training microscope image 20′ and the target image 40. The output image 42 is ideally intended to correspond to the target image 40. To this end, a loss function L2 can capture differences between these images, whereby model parameter values of the second image-to-image model M2 are iteratively adjusted, process P17.

For the second image-to-image model M2, it is again possible to use a cGAN structure instead of the shown loss function L2. In this case, a discriminator receives, e.g., either a pair consisting of a training microscope image 20′ and an associated target image 40 or a pair consisting of a training microscope image 20′ and an associated output image 42. Alternatively or additionally, a discriminator can be used in the cGAN structure which receives a pair consisting of a downscaled target image 40A and an associated target image 40 or a pair consisting of a downscaled target image 40A and an associated output image 42. Two different discriminators are suitable in particular when, as illustrated, the second image-to-image model M2 comprises two input paths M2a and M2b which run into a common model trunk M2c. The first input section M2a processes solely the input downscaled target image 40A (i.e., the result image 30′ and, in the inference phase, the result image 30 shown in FIG. 2). The second input section M2b processes solely the training microscope image 20′ (or the microscope image 20 in the inference phase). The two outputs of the input paths/input sections M2a and M2b have the same image size (but can have different depths) and are concatenated. The resulting tensor is processed further by the model trunk M2c. In a cGAN design with two loss functions, the model parameter values of the model trunk M2c and the first input section M2a can be adjusted when the error of the loss function is used which receives the downscaled target image 40A and either the output image 42 or the target image 40 as an image pair. The model parameter values of the model trunk M2c and the second input section M2b, on the other hand, are adjusted when the error of the loss function is used which receives the training microscope image 20′ and either the output image 42 or the target image 40 as an image pair.

The first and second image-to-image models M1, M2 can comprise a plurality of processing blocks with convolutional layers, in particular according to a U-Net. Instead of a cGAN design, it is also possible to use a diffusion model or another network design known per se.

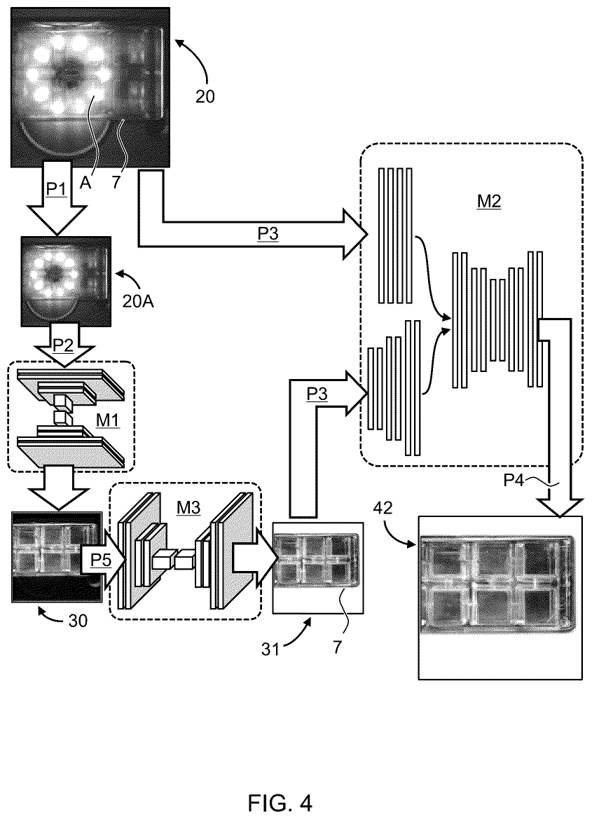

### FIG. 4: Embodiment with Interposed Image-to-Image Model

FIG. 4 shows a further example embodiment according to the invention, which differs from the embodiment of FIG. 2 by a further image-to-image model M3. The further image-to-image model M3 is interposed between the first image-to-image model M1 and the second image-to-image model M2. It receives the result image 30 of the first image-to-image model M1 as input (process P5) and calculates therefrom a result image in processed form 31. The result image in processed form 31 is input into the second image-to-image model M2 in process P3 instead of the result image 30.

The result image in processed form 31 can have the same image resolution as the result image 30 or in any case a lower image resolution than the microscope image 20 and the output image 42.

The further image-to-image model M3 changes an image property of the result image 30, in the illustrated example the visibility of a background. In the result image in processed form 31, only the imaged object (a sample carrier 7) is visible while a background has been suppressed or removed.

Any number of further image-to-image models can be concatenated in the illustrated manner before their output is input into the second image-to-image model M2.

In this case, the output image 42 differs from the microscope image 20 both in the image property that is changed by the first image-to-image model M1 and in the image property that is changed by each additional image-to-image model M3.

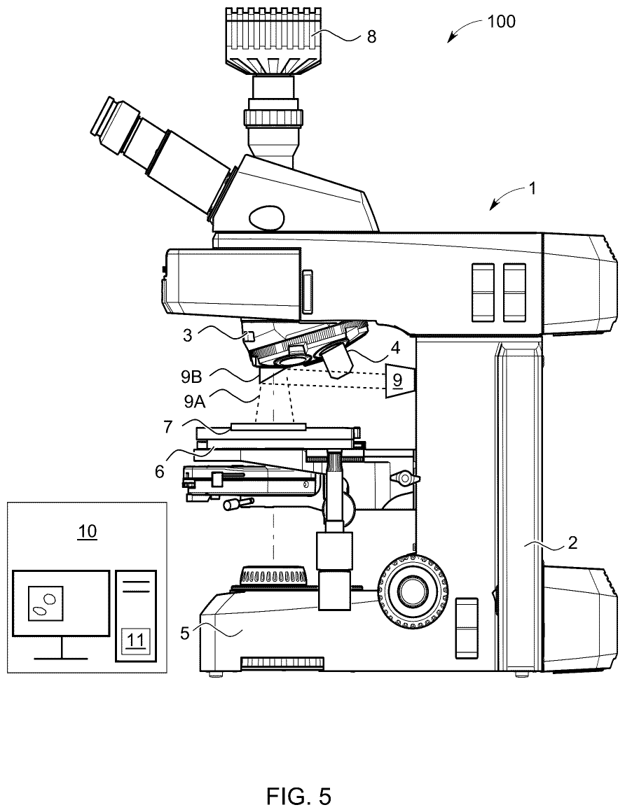

### FIG. 5: Microscope

FIG. 5 shows an example embodiment of a microscopy system 100 according to the invention. The microscopy system 100 comprises a computing device 10 and a microscope 1, which is a light microscope in the illustrated example, but which in principle can be any type of microscope. The microscope 1 comprises a stand 2 via which further microscope components are supported. The latter can in particular include: an illumination device 5; an objective changer/revolver 3, on which an objective 4 is mounted in the illustrated example; a sample stage 6 with a holding frame for holding a sample carrier 7; and a microscope camera 8. When the objective 4 is pivoted into the light path of the microscope, the microscope camera 8 receives detection light from a sample area in which a sample can be located in order to capture a sample image. In principle, a sample can be or comprise any object, fluid or structure. The microscope 1 optionally comprises an additional overview camera 9 for capturing an overview image of a sample environment. A field of view 9A of the overview camera 9 is larger than a field of view when a sample image is captured. In the illustrated example, the overview camera 9 views the sample carrier 7 via a mirror 9B. The mirror 9B is arranged on the objective revolver 3 and can be selected instead of the objective 4. In variants of this embodiment, the mirror is omitted or a different arrangement of the mirror or a different deflecting element is provided.

The microscope image, the training microscope images and/or the target images, i.e., the raw data required for these images, can be captured by the microscope 1. The computing device 10 can be configured to carry out the described method variants or contain a computer program 11 by means of which the described method processes are carried out.

The variants described with reference to the different figures can be combined with one another. The described example embodiments are purely illustrative and variants of the same are possible within the scope of the attached claims.

### LIST OF REFERENCE SIGNS

1 Microscope
2 Stand
3 Object revolver
4 (Microscope) objective
5 Illumination device
6 Sample stage
7 Sample carrier
8 Microscope camera
9 Overview camera
9A Field of view of the overview camera
9B Mirror
10 Computer/Computing device
11 Computer program
20 Microscope image
20′ Training microscope images
20 Downscaled microscope image
20A′ Downscaled training microscope images
30 Result image of the first image-to-image model M1
30′ Result image calculated from the training microscope image 20′
31 Result image in processed form
35 Output image of the image-to-image model M′
40 Target images for the training microscope images
40A Downscaled target images
42 Output image of the second image-to-image model M2
100 Microscopy system
A Artefact
L1 Loss function for training the first image-to-image model M1
L2 Loss function for training the second image-to-image model M2
L′ Loss function for training the image-to-image model M′
M′ Image-to-image model of the prior art
M1 First image-to-image model
M2 Second image-to-image model
M2a, M2 First and second input paths of the second image-to-image model
M2c Model trunk of the second image-to-image model
M3 Further image-to-image model
P1-P17 Processes of variants of the method according to the invention
T Training data

What is claimed is:

1. A computer-implemented method for image processing a microscope image, comprising:
downscaling the microscope image to create a downscaled microscope image;
inputting the downscaled microscope image into a first image-to-image model, which outputs a result image that differs in an image property from the downscaled microscope image; and
inputting the microscope image together with the result image into a second image-to-image model for calculating an output image which has a higher image resolution than the result image and resembles the result image in the image property.

2. The computer-implemented method according to claim 1, further comprising:
providing training data which comprises a plurality of training microscope images and associated target images, and wherein the training microscope images and the target images differ in an image property;
calculating downscaled training microscope images from a plurality of the training microscope images, and calculating downscaled target images from the associated target images; and
training the first image-to-image model with downscaled training microscope images as inputs and downscaled target images as targets.

3. The computer-implemented method according to claim 2,
wherein an image resolution of the downscaled training microscope images and of the downscaled target images used in the training of the first image-to-image model is lower than an image resolution of the microscope image; and
wherein the first image-to-image model is designed to calculate the result image with an image resolution that is lower than an image resolution of the microscope image.

4. The computer-implemented method according to claim 1, which further comprises:
analyzing the microscope image to determine a structure size of depicted structures;
and setting a scaling factor for downscaling the microscope image as a function of the structure size.

5. The computer-implemented method according to claim 2,
generating the downscaled training microscope images for the first image-to-image model by downscaling training microscope images so that depicted structures have a common structure size within a predetermined pixel range.

6. The computer-implemented method according to claim 1,
wherein the at least one image property relates to one or more of the following: a contrast type, a staining method, a visibility of artefacts, an object visibility, information regarding a local defocusing or contamination, a segmentation, a distortion or perspective representation, a white balance or a de-vignetting.

7. The computer-implemented method according to claim 1, further including:
inputting the result image calculated by the first image-to-image model into the second image-to-image model in unaltered form or in processed form.

8. The computer-implemented method according to claim 7, further including:
upscaling the result image calculated by the first image-to-image model before it is input into the second image-to-image model.

9. The computer-implemented method according to claim 7, further including:
calculating the processed form of the result image by a further image-to-image model,
wherein the processed form of the result image differs from the unaltered form in at least one further image property.

10. The computer-implemented method according to claim 2,
wherein in a training of the second image-to-image model, an input into the second image-to-image model:
A) comprises one of the training microscope images, as well as simultaneously
B) a downscaled target image associated with the training microscope image, or a result image calculated from the training microscope image by the first image-to-image model, or a processed image based on the downscaled target image and/or on the result image calculated from the training microscope image;
wherein the method further includes using the target image associated with said training microscope image as a target in the training of the second image-to-image model.

11. The computer-implemented method according to claim 1,
wherein the result image has a lower image resolution than the microscope image,
wherein the second image-to-image model comprises a first input section with processing layers in which the input result image is upscaled while the microscope image is not used in the first input section; and
wherein the method includes processing an output of the first input section together with the microscope image by subsequent processing layers to calculate the output image.

12. A microscopy system including:
a microscope for imaging; and
a computing device configured to carry out the computer-implemented method according to claim 1.

13. A non-transitory computer-readable medium comprising a computer program comprising instructions which, when the program is executed by a computer, cause the computer to carry out the method according to claim 1.
